(19) United States
(12) Patent Application Publication
(10) Pub. No.: US 2007/0211492 A1
(43) Pub. Date: Sep. 13, 2007

(54) Backlight module and driving circuit board of light emitting diodes

(75) Inventor: Feng-Li Lin, Taishan Twonship (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/715,232

(22) Filed: Mar. 8, 2007

(30) Foreign Application Priority Data
Mar. 9, 2006 (TW) 095107921
May 12, 2006 (CN) 200610079196.3

(51) Int. Cl. F21V 7/04

(52) U.S. Cl. 362/612

(57) ABSTRACT

A backlight module having a light emitting surface includes a housing, a driving circuit board of light emitting diodes (LED driving circuit board) and an optical film. The LED driving circuit board is disposed on the housing. The LED driving circuit board has a substrate, a plurality of LED dies and a driving circuit. The LED dies are directly disposed on the substrate. The LED dies are electrically connected to the driving circuit and driven by the driving circuit. The optical film is adjacent to the LED driving circuit board. A driving circuit board of light emitting diodes is also disclosed.

### BACKGROUND OF THE INVENTION

1. Field of Invention

The invention relates to a backlight module and a driving circuit board of light emitting diodes, and, in particular, to a backlight module used in a display and a driving circuit board of light emitting diodes (hereinafter referred to as an LED driving circuit board).

2. Related Art

A light emitting diode (LED) is a light emitting device made of semiconductor materials and having two electrode terminals. A voltage is applied across the terminals to generate a small current across a semiconductive material, in which electrons combine with holes, releasing residual energy in the form of light.

As opposed to the typical incandescent light bulb, the light emitting diode emits cold light, consumes less power, lasts longer, does not require warm up time, and responds quickly. In addition, the LED is small, vibration-resistant, suitable for the mass production, and can be made into an extremely small device or an array device according to the requirements of applications. At present, the LEDs have been widely used in indicators and displays of information, communication and consumer electronic products, and have become an indispensable part of daily life. Recently, LEDs have been used to serve as a light source in a backlight module of a liquid crystal display (LCD) and are beginning to replace the conventional cold cathode fluorescent lamp.

Referring to FIGS. 1 and 2, a conventional backlight module 1 having a light source composed of LEDs has a housing 11, a plurality of LED units 12, a carrier 13, a driving circuit board 14 and at least one optical film 15.

Each LED unit 12 has a plurality of LED devices 121 and a printed circuit board 122. The LED devices 121 are disposed on the printed circuit board 122. Then, each LED unit 12 is fixed on the carrier 13 which is fixed to the housing 11 by way of screwing (not shown). The carrier 13 may be made of a metal material to assist in dissipating heat of the LED unit 12.

The driving circuit board 14 has a driving circuit, an active device and a passive device of the LED unit 12, and is fixed to the carrier 13 in opposite to the LED unit 12.

However, the process of assembling the prior art backlight module 1 is very complicated. First, the LED device 121 is disposed on the printed circuit board 122 to form the LED unit 12, and then each LED unit 12 and the driving circuit board 14 are fixed to the carrier 13. Thereafter, the carrier 13 is fixed to the housing 11 by way of screwing. Finally, the optical film 15, such as a diffuser plate, is disposed on the carrier 13. The complicated assembling steps increase the manufacturing cost of the product.

FIG. 3 is a schematic illustration showing a structure of the conventional LED device 121. A substrate 121a of the LED device 121 is disposed on a heat dissipating seat 121b to facilitate the heat dissipation, and a die 121c is disposed on the substrate 121a and is bonded to a lead frame 121d by way of wire bonding so that the die 121c is electrically connected to other devices through the lead frame 121d. As shown in the drawing, the die 121c of the LED and the substrate 121a are first packaged and then mounted on the heat dissipating seat 121b followed by the wire bonding processes. So, the process of manufacturing the LED device 121 is quite complicated.

Thus, it is an important subject of the invention to provide a backlight module and a driving circuit board of light emitting diodes capable of solving the problems of the complicated assembling processes and the increased manufacturing cost.

### SUMMARY OF THE INVENTION

In view of the foregoing, the invention is to provide a backlight module having light emitting diode dies and a driving circuit, which are disposed on the same substrate, and an LED driving circuit board.

To achieve the above, a backlight module according to the invention has a light emitting surface and includes a housing, an LED driving circuit board and an optical film. The LED driving circuit board is disposed on the housing. The LED driving circuit board has a substrate, a plurality of LED dies and a driving circuit. The LED dies are directly disposed on the substrate, electrically connected to the driving circuit, and driven by the driving circuit. The optical film is adjacent to the LED driving circuit board.

To achieve the above, the invention also discloses an LED driving circuit board including a substrate, a plurality of LED dies and a driving circuit. The LED dies are directly disposed on the substrate. The LED dies are electrically connected to the driving circuit and driven by the driving circuit.

As mentioned above, the LED dies are directly disposed on the substrate in the backlight module and the LED driving circuit board according to the invention. Compared to the prior art, the LED dies of the invention are directly disposed on the substrate by way of SMT, embossing, flip-chip bonding or wire bonding. So, the cost of the material which carries the substrate in the prior art, wherein the LED dies have to be packaged, can be saved. In addition, the backlight module of the invention can be assembled in a very convenient manner because the LED driving circuit board has to be fixed on the housing followed by the arrangement of the optical film. In the embodiment of the invention, the LED driving circuit board may further have an auxiliary pad. When one of the LED dies is damaged, it is unnecessary to replace the circuit board on which a plurality of LEDs is disposed, and the new LED die only has to be electrically connected to the auxiliary pad. So, it is possible to prevent the material from being wasted.

### BRIEF DESCRIPTION OF THE DRAWINGS

The invention will become more fully understood from the detailed description given herein below illustration only, and thus is not limitative of the present invention, and wherein:

FIG. 1 is a schematic top view showing a backlight module having a plurality of LED units;

FIG. 2 is a schematic illustration showing a cross-section taken along a line A-A′ of FIG. 1;

FIG. 3 is a schematic illustration showing a conventional LED device;

FIG. 4 is a schematic illustration showing a backlight module according to the invention;

FIG. 5 is a partial schematic illustration showing a LED driving circuit board of the backlight module according to the invention;

FIG. 6 is another schematic illustration showing the LED driving circuit board of the backlight module according to the invention;

FIG. 7 is a schematic illustration showing a substrate having an auxiliary pad in a dashed line circle in the LED driving circuit board of FIG. 5;

FIG. 8 is another schematic illustration showing a substrate having an auxiliary pad in a dashed line circle in the LED driving circuit board of FIG. 5; and

FIG. 9 is another schematic illustration showing a LED driving circuit board according to the invention.

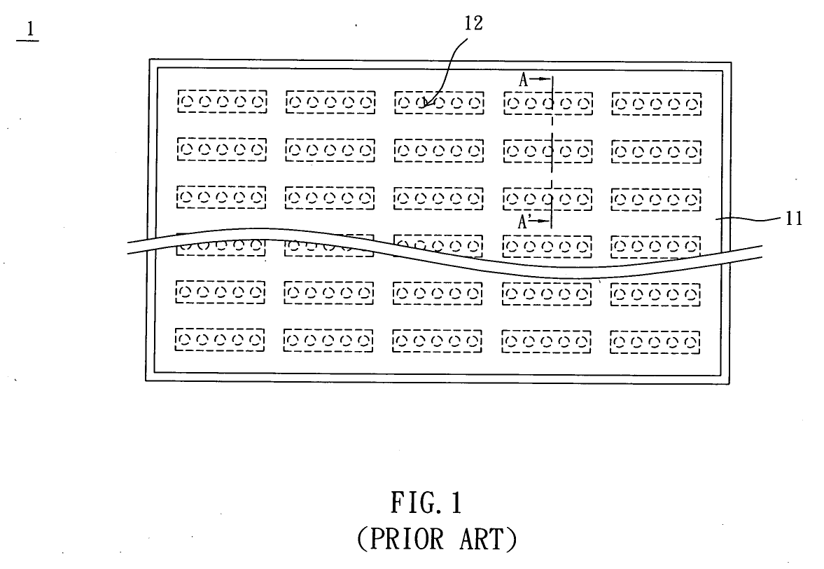

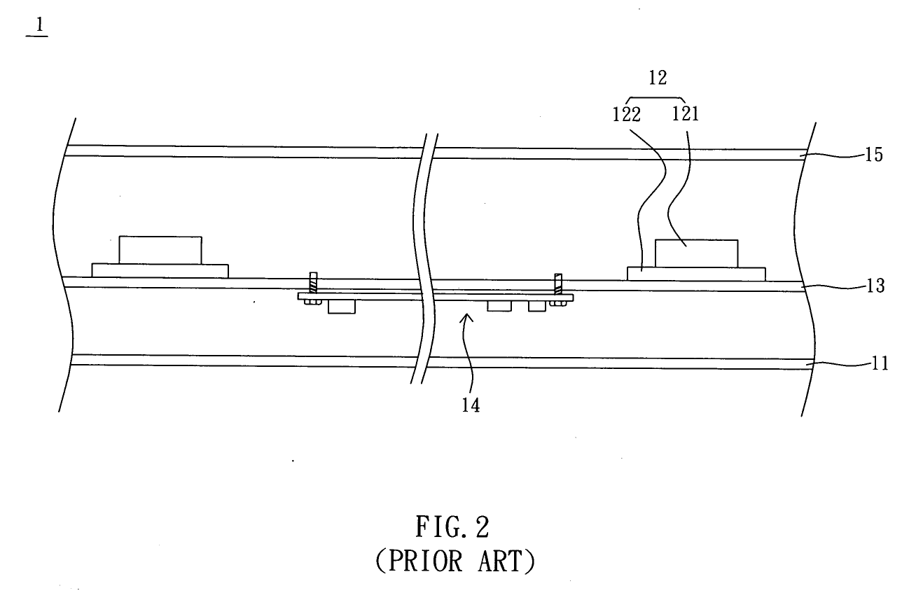

### DETAILED DESCRIPTION OF THE INVENTION

The present invention will be apparent from the following detailed description, which proceeds with reference to the accompanying drawings, wherein the same references relate to the same elements.

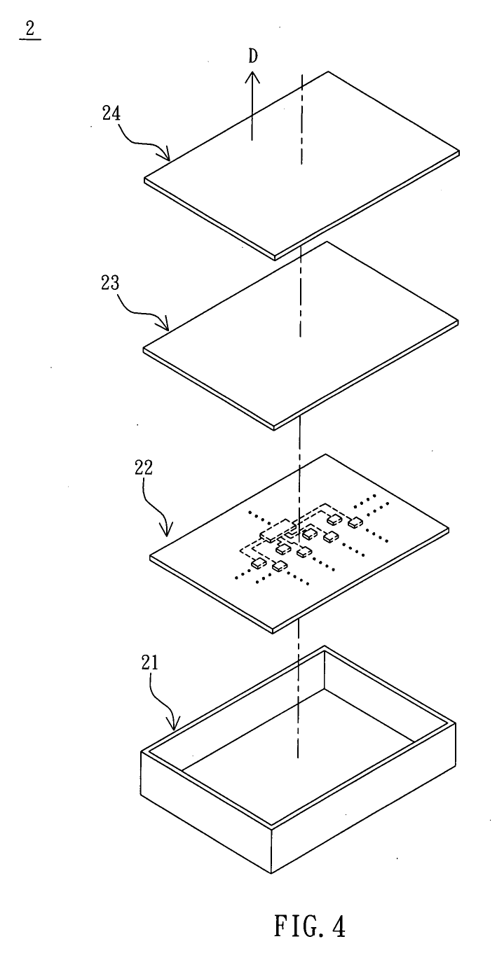

The backlight module according to the embodiment of the invention will be described with reference to FIGS. 4 to 8.

Referring to FIG. 4, a backlight module 2 includes a housing 21, a LED driving circuit board 22 and an optical film 23. The backlight module 2 may be an edge lighting backlight module or a bottom lighting backlight module and is a bottom lighting backlight module in this embodiment. The backlight module 2 has a light emitting surface D having roughly equal size to that of the LED driving circuit board 22.

The housing 21 may be made of a metal material or a plastic material. The size and the shape of the housing 21 may be designed according to the actual requirement of the backlight module 2. For example, the housing 21 may be a frame body, may have a flat shape or other shapes. The LED driving circuit board 22 may be disposed on the housing 21 and supported by the housing 21 by way of screwing or other connecting methods.

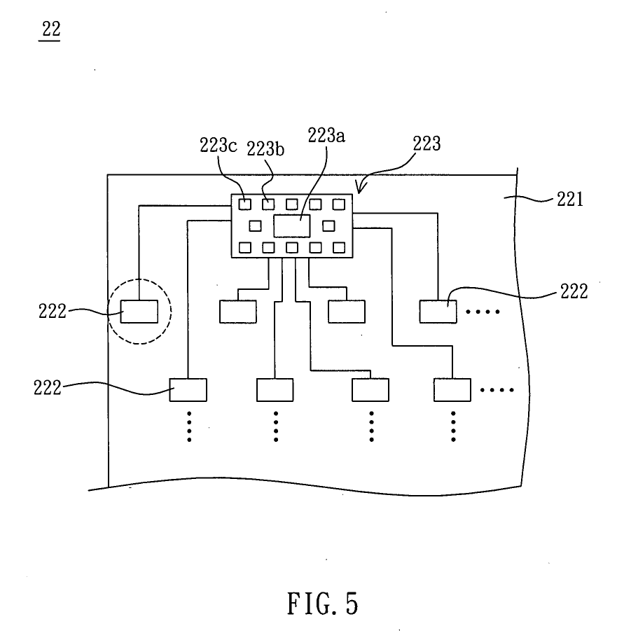

Referring to FIG. 5, the LED driving circuit board 22 has a substrate 221, a plurality of LED dies 222 and a driving circuit 223.

The substrate 221 may be a printed circuit substrate or a glass circuit substrate. The heat expansion coefficient of the glass substrate is similar to the heat expansion coefficient of the LED die 222.

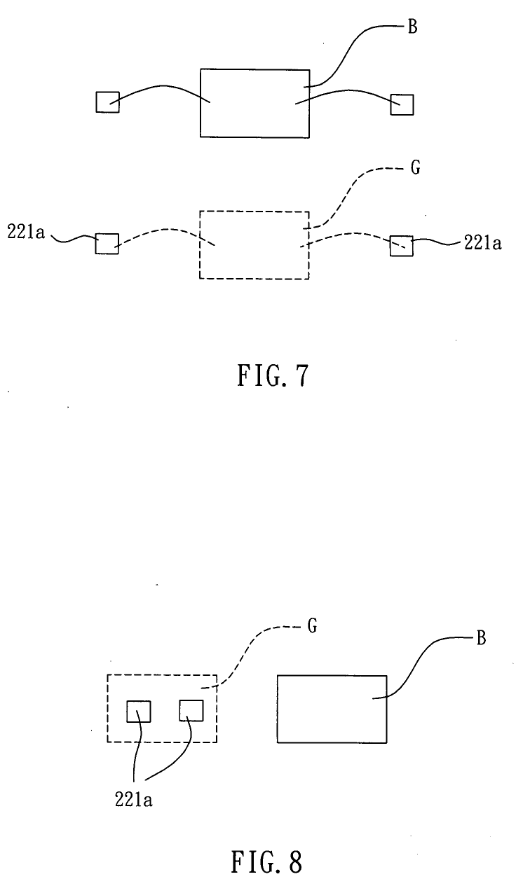

The LED dies 222 are directly disposed on the substrate 221. In the example of FIG. 5, some LED dies 222 are illustrated. The number and the arrangement of the LED dies 222 may be designed according to the actual requirements of the product. To say that the LED dies 222 are “directly disposed on the substrate” means that the LED dies 222 are directly bonded to the bonding pads 221a (see FIG. 7 or 8) of the substrate 221 by way of surface mounting technology (SMT) or embossing. Herein, it is not intended to restrict that only the LED dies 222 after being packaged can be disposed on the substrate 221.

In this embodiment, the LED dies 222 may output red light, green light, blue light or other colored light. Of course, the LED dies 222 may all output the same color.

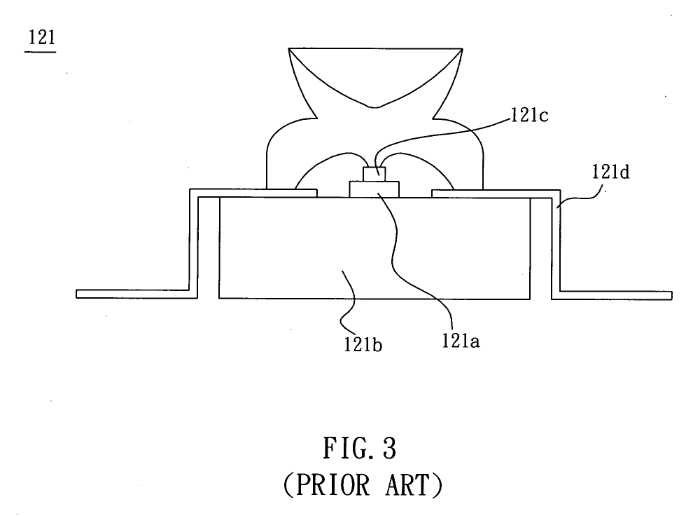

The LED dies 222 are directly disposed on the substrate 221 and electrically connected to the driving circuit 223 by way of surface mounting technology (SMT), flip-chip bonding or wire bonding so that the driving circuit 223 can drive each of the LED dies 222. So, no substrate (e.g., 121a in FIG. 3) need be provided to support the LED dies 222 and thus the material cost can be reduced. Furthermore, the number of manufacturing steps for disposing the LED dies 222 on the substrate 221 can be reduced.

As shown in FIG. 5, the driving circuit 223 is electrically connected to the LED die 222 and drives each of the LED dies 222. In this embodiment, the driving circuit 223 includes a driving circuit die 223a, which is directly disposed on the substrate 221 and electrically connected to each LED die 222 so as to drive and control a plurality of light sources.

In addition, the driving circuit 223 may further include an active device 223b or a passive device 223c. The active device 223b or the passive device 223c is electrically connected to the driving circuit die 223a. In this embodiment, the driving circuit 223 includes a plurality of active devices 223b and a plurality of passive devices 223c, wherein the active device 223b may be a switch device, such as a transistor or a diode. The passive device 223c may be a capacitor, a resistor, an inductor or a combination thereof.

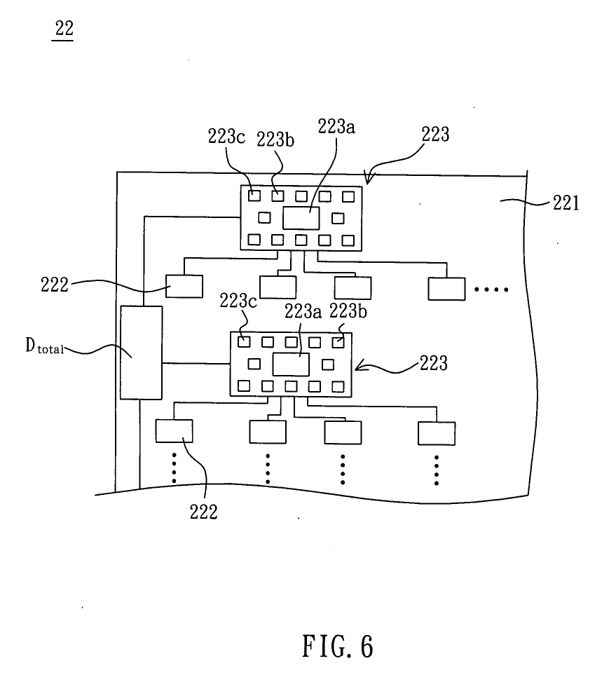

Referring to FIG. 6, the driving circuit 223 may also have a plurality of driving circuit dies 223a respectively electrically connected to the LED dies 222. For example, the LED dies 222 in the same row are electrically connected to one driving circuit die 223a, and several driving circuit dies 223a are respectively electrically connected to a total driving circuit die Dₜₒₜₐₗ, as shown in FIG. 6.

Please refer to FIGS. 5, 7 and 8 simultaneously. FIGS. 7 and 8 are schematically enlarged views showing the LED die 222 and its neighboring region contained in the dashed line circle of FIG. 5. In this embodiment, the substrate 221 may further include an auxiliary pad 221a, which may be a bonding pad or a die pad to be electrically connected to the driving circuit 223 or the LED die 222.

In the past, in the process of testing before the product is shipped out, if one of the LEDs is found to be damaged, the circuit board on which a plurality of LED devices is disposed had to be directly replaced, and some LED devices having the normal functions and thus the materials were wasted. In this embodiment, the substrate 221 has the auxiliary pad 221a electrically connected to the LED die 222 or the driving circuit die 223a. Thus, when one LED die B is damaged, a good LED die G, indicated by the dashed line, may be disposed in the space adjacent to the die B and electrically connected to the auxiliary pad 221a by way of wire bonding, embossing, SMT or flip-chip bonding. In FIG. 7, the die G is bonded to the auxiliary pad 221a by way of wire bonding. In FIG. 8, the die G is bonded to the auxiliary pad 221a by way of flip-chip bonding. The damaged LED B may remain so that the maintenance steps may be reduced. Thus, the material cost and the maintenance steps may be reduced.

Referring again to FIG. 4, the optical film 23 is adjacent to the LED driving circuit board 22. In this embodiment, the optical film 23 may be a diffuser film or a diffuser plate.

In addition, the backlight module 2 may further include an optical film assembly 24 disposed on the optical film 23. The optical film assembly 24 may include a diffuser plate, a polarizer or a brightness enhancement film.

In this embodiment, the backlight module 2 can be assembled in a rapid and simple manner by fixing the LED driving circuit board 22 on the housing 21 followed by the arrangement of the optical film 23.

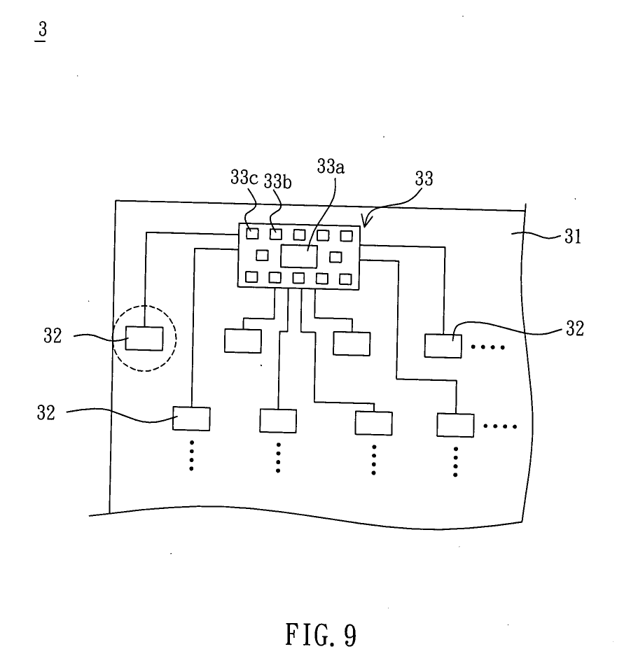

Next, the LED driving circuit board according to the embodiment of the invention will be described with reference to FIG. 9.

Referring to FIG. 9, a LED driving circuit board 3 includes a substrate 31, a plurality of LED dies 32 and a driving circuit 33. In this embodiment, the LED driving circuit board 3 and the LED driving circuit board 22 of the backlight module 2 may have the same effect and technological features, so detailed descriptions thereof will be omitted.

In addition to the application to the backlight module 2, the LED driving circuit board 3 may further directly serve as a LED display. The driving circuit 33 drives the plurality of LED dies 32 to make the LED dies 32 emit light. The LED dies 32 may output the light with the same color or different colors.

In summary, the LED dies are directly disposed on the substrate in the backlight module and the LED driving circuit board according to the invention. Compared to the prior art, the LED dies of the invention are directly disposed on the substrate by way of SMT, embossing, flip-chip bonding or wire bonding. So, the cost of the material which carries the substrate in the prior art, wherein the LED dies have to be packaged, can be saved. In addition, the backlight module of the invention can be assembled in a very convenient manner because the LED driving circuit board has to be fixed on the housing followed by the arrangement of the optical film. In the embodiment of the invention, the LED driving circuit board may further have an auxiliary pad. When one of the LED dies is damaged, it is unnecessary to replace the circuit board on which a plurality of LEDs is disposed, and the new LED die only has to be electrically connected to the auxiliary pad. So, it is possible to prevent the material from being wasted.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backlight module having a light emitting surface, the backlight module comprising:
a housing;
an LED (Light Emitting Diode) driving circuit board, which has a substrate, a driving circuit and a plurality of LED dies, wherein the LED driving circuit board is disposed on the housing, the LED dies are directly disposed on the substrate, electrically connected to the driving circuit and driven by the driving circuit; and
an optical film disposed adjacent to the LED driving circuit board.

2. The backlight module according to claim 1, wherein the substrate is a printed circuit substrate or a glass circuit substrate.

3. The backlight module according to claim 1, wherein a size of the LED driving circuit board is substantially the same as a size of the light emitting surface.

4. The backlight module according to claim 1, wherein the LED dies is electrically connected to the driving circuit by way of flip-chip bonding or wire bonding.

5. The backlight module according to claim 1, wherein the driving circuit comprises a driving circuit die electrically connected to the LED dies.

6. The backlight module according to claim 5, wherein the driving circuit die is directly disposed on the substrate.

7. The backlight module according to claim 1, wherein the driving circuit further comprises at least one active device electrically connected to the driving circuit.

8. The backlight module according to claim 1, wherein the driving circuit further comprises at least one passive device electrically connected to the driving circuit.

9. The backlight module according to claim 1, wherein the substrate further comprises at least one auxiliary pad electrically connected to the driving circuit or the LED die.

10. The backlight module according to claim 9, wherein the auxiliary pad is a die pad or a bonding pad.

11. An LED (Light Emitting Diode) driving circuit board, comprising:
a substrate;
a plurality of LED dies directly disposed on the substrate; and
a driving circuit, wherein the LED dies are electrically connected to the driving circuit and driven by the driving circuit.

12. The LED driving circuit board according to claim 11, wherein the substrate is a printed circuit substrate or a glass circuit substrate.

13. The LED driving circuit board according to claim 11, wherein the LED dies is electrically connected to the driving circuit by way of flip-chip bonding or wire bonding.

14. The LED driving circuit board according to claim 11, wherein the driving circuit comprises a driving circuit die electrically connected to the LED dies.

15. The LED driving circuit board according to claim 11, wherein the driving circuit die is directly disposed on the substrate.

16. The LED driving circuit board according to claim 11, wherein the driving circuit further comprises at least one active device electrically connected to the driving circuit.

17. The LED driving circuit board according to claim 11, wherein the driving circuit further comprises at least one passive device electrically connected to the driving circuit.

18. The LED driving circuit board according to claim 11, wherein the substrate further comprises at least one auxiliary pad electrically connected to the driving circuits.

19. The LED driving circuit board according to claim 18, wherein the auxiliary pad is a die pad or a bonding pad.
